(19) United States
(12) Patent Application Publication
(10) Pub. No.: US 2023/0150180 A1
(43) Pub. Date: May 18, 2023

(54) DEVICE AND METHOD FOR INJECTION MOLDING

(71) Applicant: EV Group E. Thallner GmbH, St. Florian am Inn (AT)

(72) Inventors: Gerald MITTENDORFER, St. Florian am Inn (AT); Markus WIMPLINGER, St. Florian am Inn (AT); Friedrich Paul LINDNER, St. Florian am Inn (AT)

(73) Assignee: EV Group E. Thallner GmbH, St. Florian am Inn (AT)

(21) Appl. No.: 17/910,660

(22) PCT Filed: Apr. 1, 2020
(86) PCT No.: PCT/EP2020/059281

§ 371 Date: Sep. 9, 2022

(51) Int. Cl. B29C 45/76; B29C 45/14; B29C 45/26

(52) U.S. Cl. CPC B29C 45/768; B29C 45/14; B29C 45/26; B29C 2945/76163; B29C 2945/76294; B29C 2945/76357; B29C 2945/76568; B29C 2945/76772; B29C 2945/76836

(57) ABSTRACT

A method and device for injection moulding, in particular for micro-injection moulding, at least comprising a mould with a first mould half and a second mould half, wherein the first mould half and the second mould half define an injection moulding space in the closed state of the mould, and an insert arranged in the injection moulding space.

### FIELD OF INVENTION

The invention relates to a method and a device for injection moulding. Injection moulding as production for micro-replication is a known technology.

### BACKGROUND OF INVENTION

With increasing demands on the precision of the produced injection moulded articles, the technology has reached the natural limits of the polymer-processing industry. In particular, the increased demands on the shape and position tolerances of injection moulded articles produced with injection moulding are not adequately implemented with the existing methods. If, for example, the front side and the rear side of an injection mould are to be aligned with one another, the injection moulded articles can currently only be produced with tolerances of around 10 micrometres.

For injection moulded articles which are used in certain branches of industry such as information technology, laser technology or communication network technology, these orders of magnitude are unacceptably high, since the accuracy requirements, especially on light conductors, lie in the micrometre or sub-micrometre range. With conventional production methods of machine construction, no further improvements with more accurate production can be achieved on account of the production tolerances of the plants.

Injection moulding technology can be extended by methods from the semiconductor industry, in order to be able to produce injection moulded articles with increased accuracy.

The production methods and basic approaches of machine construction and the semiconductor industry differ from one another so fundamentally that the production methods or the achievable accuracies are not arbitrarily scalable. In other words, in the semiconductor industry in particular, accuracies and surface qualities are achieved which cannot be produced conventionally. The methods of the semiconductor industry, however, cannot be transferred to machine construction on account of the potential scaling (length: linear, area: quadratic, volume: cubic) of the dimensions.

The opportunity for further commercialisation of novel injection moulded articles is thus opened up. In particular, the alignment of the moulds or any inserts inserted therein has hitherto been carried out in an inadequate manner. Use is normally made of moulds with corresponding moulding surfaces or inserts with corresponding moulding surfaces, in order to transfer the desired structures to the injection moulding compound subsequently curing in the mould.

The alignment of the mould or the inserts takes place in an opened state, in which two or more mould halves or mould parts do not yet provide an injection moulding space for the injection moulding compound subsequently introduced therein. After the transfer into the closed state of the respective mould for the injection moulding, it is no longer possible to align the mould halves or the insert/inserts arranged in the injection moulding space with one another. Alignment errors, in particular those which need to be corrected for the high demands on the micro-injection moulded article, can thus only take place in the opened state of the mould. An alignment error of the mould or the insert/inserts can again occur during or after the closing of the mould. In particular, series production of injection moulded articles with the same mould or the same insert/inserts for the injection moulding cannot therefore be carried out sufficiently precisely.

### SUMMARY OF INVENTION

It is therefore an objective of the present invention to provide a device and a method, which at least partially, in particular completely, overcomes the drawbacks of the prior art. It is also an objective of the present invention to provide an improved device for injection moulding and an improved method for injection moulding.

In particular, it is an objective of the present invention to provide a device and a method with which the production precision of the produced components or injection moulded articles is increased.

The existing problems are solved with the features of the coordinated claims. Advantageous developments of the invention are specified in the sub-claims. All combinations of at least two features specified in the description, in the claims and/or the drawings also fall within the scope of the invention. In the stated value ranges, values lying within the stated limits should also be deemed to be disclosed as limiting values and can be claimed in any combination.

Accordingly, the invention relates to a device for injection moulding, in particular for micro-injection moulding, at least comprising:

a mould with a first mould half and a second mould half, wherein the first mould half and the second mould half define an injection moulding space in the closed state of the mould and

at least one insert arranged in the injection moulding space, wherein the at least one insert comprises at least partially a polymer.

The device can also comprise two inserts or more, which at least partially comprise a polymer.

The at least one insert can preferably be aligned, in particular with a further insert, in the closed state of the mould.

Furthermore, the invention relates to a method for injection moulding, in particular micro-injection moulding, wherein an injection moulding space is defined by a mould with a first mould half and a second mould half in the closed state of the mould, wherein at least one insert arranged in the injection moulding space at least partially comprises a polymer.

Two or more inserts can also be arranged in the injection moulding space, which are at least partially comprise a polymer.

The at least one insert is preferably aligned in the closed state of the mould, in particular with a further insert.

In a particularly preferred embodiment according to the invention, the at least one insert comprises an elastic surface made of structured, moulded polymer, produced in particular by means of imprint lithography. In other words, the at least one insert or its surface can represent a structured soft stamp, which is used as a master for the primary shaping of the injection moulded article.

This elastic surface made of a structured, moulded polymer is referred to in the subsequent text merely as elastic structures. In a particularly preferred embodiment according to the invention, the insert comprises a substrate (back plane), in particular a plate, still more preferably a wafer, on which the polymer to be structured is deposited and imprinted in order to produce the elastic structures. In this case, the at least one insert is a component group comprising at least two components, i.e. a substrate and a soft stamp imprinted thereon. The substrate serves in particular as a carrier substrate for the soft stamp.

In particular, provision is made such that the at least one insert comprises at least partially a polymerised material.

In a particular embodiment, the at least one insert comprises at least partially an elastomer.

In a particularly preferred embodiment, the insert, in particular the elastic structures, comprises at least one of the following materials:

Silicones
vinyl-functional polymers
vinyl terminated polydimethylsiloxanes, in particular CAS: 68083-12-2
vinyl terminated diphenylsiloxane-dimethylsiloxane copolymers, in particular CAS: 68951-96-2
vinyl terminated polyphenylmethylsiloxanes, in particular CAS: 225927-21-9
vinylphenylmethyl terminated vinylphenylsiloxane copolymer, in particular CAS: 8027-82-1
vinyl terminated trifloropropylmethylsiloxanes-dimethylsiloxane copolymer, in particular CAS: 68951-98-4
vinylmethylsiloxane-dimethylsiloxane copolymer, trimethylsiloxy terminated, in particular CAS: 67762-94-1
vinylmethylsiloxane-dimethylsiloxane copolymer, silanol terminated, in particular CAS: 67923-19-7
vinylmethylsiloxane. Dimethylsiloxane copolymer, vinyl terminated, in particular CAS: 68083-18-1
vinyl rubber
vinyl Q resin dispersions, in particular CAS: 68584-83-8
vinylmethylsiloxane homopolymers, in particular CAS: 68037-87-6
vinyl T-structure polymers, in particular CAS: 126681-51-9
monovinyl functionalised polydimethylsiloxane, symmetrical or asymmetrical, in particular CAS: 689252-00-1
vinylmethylsiloxane terpolymers, in particular CAS: 597543-32-3
vinylmethoxysiloxane homopolymer, in particular CAS: 131298-48-1
vinylethoxysiloxane homopolymer, in particular CAS: 29434-25-1
vinylethoxysiloxane-propylethoxysiloxane copolymer

Hydrid-Functional Polymers
hydrid terminated polydimethylsiloxanes, in particular CAS: 70900-21-9
polyphenylmethylsiloxane, hydrid terminated
methylhydrosiloxane-dimethylsiloxane copolymer, trimethylsiloxy terminated, in particular CAS: 68037-59-2
methylhydrosiloxane-dimethylsiloxane copolymer, hydrid terminated, in particular CAS: 69013-23-6
polymethylhydrosiloxane, trimethylsiloxy terminated in particular CAS: 63148-57-2
polyethylhydrosiloxane, triethylsiloxy terminated, in particular CAS: 24979-95-1
polyphenyl-dimethylhydrosiloxysiloxane, hydrid terminated
methylhydrosiloxane-phenylmethylsiloxane copolymer, hydrid terminated, in particular CAS: 115487-49-5
methylhydrosiloxane-octylmethylsiloxane copolymer and terpolymer, in particular CAS: 68554-69-8
hydrid Q resin, in particular CAS: 68988-57-8

Silanol-Functional Polymers
silanol terminated polydimethylsiloxane, in particular CAS: 70131-67-8
silanol terminated diphenylsiloxane-dimethylsiloxane copolymer, in particular CAS: 68951-93-9 and/or CAS: 68083-14-7
silanol terminated polydiphenylsiloxane, in particular CAS: 63148-59-4
silanol terminated polytrifluoropropylmethylsiloxane, in particular CAS: 68607-77-2
silanol-trimethylsilyl-modified Q resin, in particular CAS: 56275-01-5

Amine-Functionalised Silicones
aminopropyl terminated polydimethylsiloxane, in particular CAS: 106214-84-0
N-ethylaminoisobutyl terminated polydimethylsiloxane, in particular CAS: 254891-17-3
aminopropylmethylsiloxane-dimethylsiloxane copolymer, in particular CAS: 99363-37-8
aminoethylaminopropylmethylsiloxane-dimethylsiloxane copolymer, in particular CAS: 71750-79-3
aminoethylaminoisobutylmethylsiloxane-dimethylsiloxane copolymer, in particular CAS: 106842-44-8
aminoethylaminopropylmethoxysiloxane-dimethylsiloxane copolymer, in particular CAS: 67923-07-3

Hindered Amine-Functionalised Siloxanes (Hindered Amine Functional Siloxanes)
tetramethylpipridinyloxypropylmethylsiloxane-dimethylsiloxane copolymer, in particular CAS: 182635-99-0

Epoxy-Functionalised Silicones
epoxypropoxypropyl terminated polymethylsiloxanes, in particular CAS: 102782-97-8
epoxypropoxypropylmehylsiloxane-dimethylsiloxane copolymer, in particular CAS: 68440-71-7
epoxypropoxypropyl terminated polyphenylmethylsiloxanes, in particular CAS: 102782-98-9
epoxypropoxypropyldimethoxysilyl terminated polydimethylsiloxanes, in particular CAS: 188958-73-8
tris(glycidoxypropyldimethylsiloxy)phenylsilane, in particular CAS: 90393-83-2
mono-(2,3-epoxy)-propylether terminated dimethoxsiloxanes, in particular CAS: 127947-26-6
epoxycyclohexylethylmethylsiloxane-dimethylsiloxane copolymer, in particular CAS: 67762-95-2
(2-3% epoxycyclohexylethylmethylsiloxane)(10-15% methoxypolyalkyleneoxymethylsiloxane)-dimethylsiloxane terpolymer, in particular CAS: 69669-36-9

Cycloaliphatic Epoxysilanes and Silicones
epoxycyclohexylethylmethylsiloxane-dimethylsiloxane copolymer, in particular CAS: 67762-95-2
(2-3% epoxycyclohexylethylmethylsiloxane)(10-15% methoxypolyalkyleneoxymethylsiloxane)-dimethylsiloxane terpolymer, in particular CAS: 69669-36-9
epoxycyclohexylethyl terminated polydimethylsiloxanes, in particular CAS: 102782-98-9

Carbinol-Functionalised Silicones
carbinolhydroxyl terminated polydimethylsiloxanes, in particular CAS: 156327-07-0, CAS: 10478066-7, CAS: 68937-54-2, CAS: 161755-53-9, CAS: 120359-07-1
bis(hydroxyethyl)amine) terminated polydimethylsiloxanes
carbinol-functionalised methylsiloxane-dimethylsiloxane copolymers, in particular CAS: 68937-54-2, CAS: 68957-00-6, CAS: 200443-93-2
monocarbinol terminated polydimethylsiloxanes, in particular CAS: 207308-30-3
monocarbinol terminated polydimethylsiloxanes, in particular CAS: 218131-11-4

Methacrylates and Acrylate Functionalised Siloxanes
methacryloxypropyl terminated polydimethylsiloxanes, in particular CAS: 58130-03-3
(3-acryloxy-2-hydroxypropoxypropyl) terminated polydimethylsiloxanes, in particular CAS: 128754-61-0
acryloxy terminated ethyleneoxide-dimethylsiloxanes-ethyleneoxides ABA block copolymers, in particular CAS: 117440-21-9
methacryloxypropyl terminated branched polydimethylsiloxanes, in particular CAS: 80722-63-0
methacryloxypropylmethylsiloxane-dimethylsiloxane copolymer, in particular CAS: 104780-61-2
acryloxypropylmethylsiloxane-dimethylsiloxane copolymer, in particular CAS: 158061-40-6
(3-acryloxy-2-hydroxypropoxypropyl)methylsiloxane-dimethylsiloxane copolymer
methacryloxypropyl T-structured siloxanes, CAS: 67923-18-6
acryloxypropyl T-structured siloxanes

polyhedral oligomeric silsesquioxane (POSS)

tetraethylorthosilicate (TEOS)

poly(organo)siloxanes

polyhedral oligomeric silsesquioxane (POSS)

polydimethylsiloxane (PDMS)

tetraethylorthosilicate (TEOS)

poly(organo)siloxanes (silicone)

perfluoropolyether (PFPE).

In particular, provision is made such that the at least one insert is inserted and in particular fixed in the first mould half or in the second mould half in an opened state of the mould. In the closed state, the mould comprises in the interior the injection moulding space, which is formed by the first and the second mould half.

The at least one insert is arranged and can preferably be aligned in the injection moulding space. In this way, an alignment of the at least one insert can advantageously take place in the closed state of the mould and an alignment error can be corrected.

In particular, provision is made such that the at least one insert is movable in one or more directions relative to the mould or to the injection moulding space. The alignment error is preferably determined by measuring an injection moulded article produced by means of injection moulding.

The device and the method are preferably designed for the series production of injection moulded articles with particularly high demands on the accuracy of the shape of the injection moulded part. In particular, injection moulded parts which comprise functional areas can be produced by the device and the method. These functional areas are moulded onto the injection moulded part in particular by the alignable at least one insert, in particular during the curing of an injection moulding compound introduced into the mould.

In a preferred embodiment of the invention, provision is made such that the device comprises at least one further insert arranged in the injection moulding space, wherein the insert and/or the at least one further insert can be aligned in the closed state of the mould. In this way, injection moulded articles can be formed or produced with a plurality of inserts.

Furthermore, the inserts are advantageously aligned with one another in the closed state of the mould. Apart from a flexible design of the injection moulded article, it is advantageous that a precise alignment for the production is enabled by an alignment of the two inserts. In this embodiment, an insert is in particular arranged in the first mould half and the at least one further insert is arranged in the second mould half.

In another preferred embodiment of the invention, provision is made such that the insert and/or the at least one further insert in each case comprises/comprise a moulding surface with elastic structures. The shape of the injection moulded article can advantageously be predefined by the moulding surfaces.

By means of the elastic structures, particularly small, in particular microstructures and/or nanostructures, can advantageously be moulded onto the injection moulded part in an injection moulding process. The elasticity of the structures permits even finer and more precise moulding of the structures on the injection moulded article.

In particular, shapes which interlock or undercut can also be moulded. Rigid structures could either destroy the microstructures and/or the nanostructures or could be destroyed themselves during removal from the mould. Inclined microstructures and/or nanostructures are mentioned as an example.

By means of such a structured moulding surface, a plurality of injection moulded articles with very high demands can preferably be produced in series by means of injection moulding. A production process is thus provided, with which injection moulded articles can be produced cost-effectively, rapidly and with high quality.

The elastic structures are preferably made of a polymer, which is used in the semiconductor industry for soft stamps. Such polymers are mentioned for example in publications WO2015078520 A1 and WO2014202127 A1.

In another preferred embodiment of the invention, provision is made such that the moulding surface of the at least one insert and the moulding surface of the at least one further insert can be aligned with one another in the closed state of the mould. With the alignment of the moulding surfaces of the inserts with one another, the shape of the injection moulded article can be predefined extremely accurately. By means of the alignment of the moulding surfaces of the inserts, which can be aligned in the closed state of the mould, it is advantageously possible to predefine the position or the location of the moulding surfaces particularly precisely with respect to one another.

In another preferred embodiment of the invention, provision is made such that the structures of the moulding surface of the at least one insert and the structures of the moulding surface of the at least one further insert can be aligned with one another in the closed state of the mould.

With the alignment of the elastic structures arranged on the moulding surfaces with respect to one another, the positions of the moulded structures, on the front and the rear side of the injection moulded part, can advantageously be exactly adjusted with respect to one another. In particular, a requirement for some applications is that not only are the specific shapes and structures particularly precisely moulded on the injection moulding compound or on the injection moulded part, but also that the respective positions of the moulded shapes and structures with respect to one another are moulded as exactly as possible on the injection moulded part.

In another preferred embodiment of the invention, provision is made such that at least one heating element is/are integrated into at least one of the mould halves and/or into the at least one insert and/or into the at least one further insert and/or into the respective structures, so that the injection moulding space, in particular an injection moulding compound conveyed into the injection moulding space, can be heated in a targeted manner by means of the at least one heating element.

The heating element can be any kind of heating. A resistance heating element, or an induction heating element, would for example be conceivable. By means of inductive heating, the interfaces of the mould or of the insert or the inserts, in particular the moulding surfaces with elastic structures which are directly in contact with the injection moulding compound during the injection moulding, can advantageously be heated. Uncontrolled curing of the injection moulding compound, in particular at the fine structures of the moulding surface of the inserts, can thus be prevented and the fluid moulding compound can advantageously be kept uniformly heated during the injection moulding process. Furthermore, the moulding quality is increased or a shaping defect on the injection moulded article to be produced is prevented. In particular, moulding of the microstructures and/or the nanostructures by means of the heated moulding surface or the heated structures is improved and simplified.

In a particularly preferred embodiment according to the invention, the heating element is incorporated in the at least one insert. If the at least one insert is a semiconductor, the heating element is designed directly as an active component, i.e. metallic strip conductors or semiconductor elements, which are suitable for converting current efficiently into Joule heat and are produced directly in at least one insert. Very efficient heating is thus enabled. The heating is preferably designed as in publication WO 2019210976.

In a another preferred embodiment of the invention, provision is made such that the at least one insert and/or the at least one further insert, in particular on the respective moulding surface and/or on a respective rear side, comprises/comprise a the plurality of alignment marks. The alignment marks are a marking which can assign a specific position on the insert.

In particular, they are regularly arranged alignment marks, in particular an alignment mark field, in which each alignment mark can be assigned a specific position in the alignment mark field. In the case of the alignment marks on the moulding surface, it can in particular be structures arranged on the moulding surface of the at least one insert.

The at least one insert preferably has alignment marks on the moulding surface and on the rear side. The positions of the alignment marks on the moulding surface are particularly preferably known to the positions of the alignment marks on the rear side of the at least one insert.

The alignment marks can preferably be detected, processed and put into a relationship with one another by an optical alignment means. The alignment marks can for example be arranged inside the mould, in particular on the rear side of the at least one insert. A particularly precise and straightforward alignment of the at least one insert is enabled by the alignment marks.

In another preferred embodiment of the invention, provision is made such that the first mould half and/or the second mould half comprises/comprise an inspection window, so that the at least one insert and/or the at least one further insert can be aligned and/or can be aligned with one another in the closed state of the mould by means of the plurality of alignment marks. The inspection window, there are conceivably also a plurality of inspection windows, are arranged in the mould in such a way that the alignment marks of the at least one insert and/or of the at least one further insert can be seen from outside the mould, in particular are visible or detectable for an optical alignment means.

The insert/the inserts can thus be aligned/aligned with one another. The inspection window is preferably arranged in the mould in such a way that, in the closed state of the mould, at least the alignment marks on the rear side of the at least one insert can be seen. A monitored relative alignment of the respective insert can thus advantageously be carried out.

In another preferred embodiment of the invention, provision is made such that the first mould half and/or the second mould half each comprises/comprise at least one positioning mechanism, so that the at least one insert and/or the at least one further insert can be aligned with the aid of the plurality of alignment marks in the closed state in the mould. The positioning mechanism is able, in particular in an automated or computer-controlled manner, to advantageously carry out the alignment of the at least one insert and/or the at least one further insert when the mould is closed.

The alignment is advantageously carried out with the aid of the alignment marks. In particular, the positioning mechanism is designed such that the at least one insert or the inserts can be aligned particularly precisely. The positioning mechanism is preferably an aligner. The insert to be aligned is fixed in the mould, but can be aligned by means of the positioning mechanism. The at least one insert can thus advantageously also be aligned in the closed mould with the aid of the alignment marks.

In another preferred embodiment of the invention, provision is made such that, with the aid of the plurality of alignment marks on the rear side of the at least one insert and/or on the rear side of the at least one further insert, the structures of the moulding surface of the at least one insert and the structures of the moulding surface of the at least one further insert can be aligned with one another in the closed state of the mould. In this embodiment, the position of the alignment marks on the rear side of the at least one insert is known in relation to the structures on the moulding surface of the at least one further insert. The insert and/or the inserts, in particular the structures important for the moulding on the injection moulded article, can thus advantageously be aligned or aligned with one another in the closed mould, solely with the aid of the alignment marks on the respective rear side. An alignment of the structures on the moulding surface of the inserts is thus advantageously possible solely by means of the alignment marks on the rear side. An alignment with the aid of the alignment marks on the rear side of the insert can for example also be carried out during the injection moulding.

In a another preferred embodiment of the method according to the invention, provision is made such that the at least one insert and at least one further insert arranged in the injection moulding space, in particular a moulding surface of the at least one insert and/or a moulding surface of the at least one further insert, are aligned with one another in the closed state of the mould in the injection moulding space. The moulding surface of the inserts, in particular the structures arranged on the moulding surface, can thus be aligned or aligned with one another with the method. As a result, the accuracy of the shape of the produced injection moulded article is advantageously increased in the injection moulding.

In another preferred embodiment of the method is according to the invention, provision is made such that the at least one insert and/or the at least one further insert is/are aligned with the aid of a plurality of alignment marks provided on the insert and/or the at least one further insert. The at least one insert and/or the at least one further insert can thus advantageously be aligned with the aid of the alignment marks.

In another preferred embodiment of the method according to the invention, provision is made such that an alignment of the at least one insert and/or of the at least one further insert is carried out on the basis of a measurement of an injection moulded article, produced according to the method for the injection moulding. After the production of an injection moulded article, the latter can be measured and analysed. The actual values of the shapes or the geometries of the injection moulded article are compared with set values. A defect in shape can be ascertained and a correction can be derived from this comparison. By realignment of the insert or of the inserts, this error can be improved iteratively by repeatedly carrying out the alignment, in particular until the defect in shape lies within a predefined tolerance range. The regions of the injection moulded article are preferably measured in which the structures arranged on the moulding surfaces are moulded, since the latter are important especially for the functionality of the produced injection moulded article. An improvement in the alignment with the aid of a produced injection moulded article can thus be achieved.

In another preferred embodiment of the method according to the invention, provision is made such that alignment is carried out by the reworking of the at least one insert and/or of the at least one further insert. On the basis of the ascertained defect in shape, a correction is carried out by alignment of the insert or the inserts. An alignment can also be achieved by reworking, in particular removing or applying corresponding material. For example, a defect in shape of the injection moulded article may be present on account of non-exact parallelism of the inserts with respect to one another in the case of inserts lying mutually opposite. In particular, this can take place by the removal of material of the insert, in particular on the rear side. Laser radiation, for example, can be used for this purpose. Defects in the shape of the injection moulded article can thus advantageously be compensated for, which for example cannot be compensated for by alignment by means of a positioning mechanism.

In another preferred embodiment of the method according to the invention, provision is made such that the method includes at least the following steps, in particular in the following sequence:
i) equipping the mould with the insert and/or with the at least one further insert,
ii) closing the mould,
iii) production of an injection moulded article, in particular by the introduction of an injection moulding compound and curing of the injection moulding compound,
iv) removal and measuring of the injection moulded article,
v) determination of an alignment error by comparison with set values,
vi) alignment of the insert and/or of the at least second insert.

The methods for injection moulding can thus be advantageously adapted iteratively to the process by alignment of the inserts.

An aspect of the present invention is based on a modification of the injection moulding process or of the injection moulding device, so that surfaces with micrometre or nanometre structures can be produced with at least partially flexible inserts, in particular inserts surface-structured by means of soft stamp technology. For the increase in injection moulding accuracy, basic approaches from the semiconductor industry are used in order to align or align with one another moulded parts or the moulding surfaces. By measuring the produced injection moulded article or the end product and feedback, the accuracy of the production process can be increased or adapted. In this connection, feedback means that the injection moulded article repeatedly produced in series is measured and any defects that may thus be found on the injection moulded article are compensated for by alignment of the inserts and/or by reworking the inserts, so that the quality of the injection moulded article produced in each case can be iteratively improved.

A functionalisation of the surface(s) of the imprinted workpiece is enabled by the device according to the invention and the method according to the invention, so that production costs can be reduced by the optimisation of the given production process and at the same time the precision of the workpiece is increased. In other words, a conventional production process can be used for the shaping. In particular, the surface functionalisation is achieved with the novel, high-precision at least one insert in the mould. The production of an injection moulded article with functional surfaces or micro- and/or nanostructured surfaces was not hitherto possible with conventional injection moulding devices or injection moulding methods.

The present invention relates to a method and a device for injection moulding, in particular micro-injection moulding. It thus involves the production of the injection moulded articles with very small structures, which are moulded by the moulding surfaces onto the injection moulding compound or the corresponding injection moulded article.

A known injection moulding device is designed such that the accuracy and/or dimensional and positional tolerances and/or surface quality and/or surface functionalisation of the produced injection moulded article are improved by means in particular of at least partially elastic, preferably microstructured inserts.

In injection moulding, an injection moulded article is generally produced in a mould in a primary shape or injection moulding space (also called an injection moulding chamber), wherein the mould is filled with an injection moulding compound. The injection moulding compound exhibits specific state variables with regard to the specific volume, temperature and filling pressure. The mould is filled under high pressure with a compressible and compressed injection moulding compound heated above the melting temperature of the injection moulding compound and subjected to a holding pressure. The temperature of the injection moulding compound lies in particular 10° C., preferably 25° C., more preferably 50° C., most preferably 75° C. above the melting temperature of the injection moulding compound. The melt solidifies under the holding pressure in the mould.

After the phase transformation into the solid state (with physically determined, unavoidable shrinkage) and in particular after atmospheric pressure is reached in the mould, the mould is opened at least in a mould parting plane and the injection moulded article removed or ejected in an automated manner.

The state-variable material, temperature, pressure as well as design and/or functionalisation of the mould are responsible for the achievable dimensional accuracy of the injection moulded article.

The first disclosed injection moulding device contains at least one modified mould with at least one insert for the adaptation and/or functionalisation of the mould and thus of the produced injection moulded article.

The insert preferably has an in particular micro- or nanostructured surface, which is replicated during the production of the injection moulded article.

The at least one insert particularly preferably has a coating, preferably a structured coating, particularly preferably a microstructured or nanostructured coating, which is replicated during the production of the injection moulded article.

It is preferable that the at least one insert has an elastic structuring, in particular with microstructures and/or nanostructures. An, in particular, at least partially rigid insert with flexible structures on its surface can thus produce a better moulding of injection moulded articles with high precision, high demands on surface structuring and/or narrow shape or position tolerances.

A functional separation is preferably made, in particular between coarse shaping and functionalisation of at least one article surface, whereby the shape and design of the mould and/or of the at least one insert establishes at least the coarse shaping and the in particular elastic structuring of the insert surface, which is replicated in the injection moulded article, determines the surface of the injection moulded article or the functionalisation of the surface of the injection moulded article.

It is conceivable for an additional, local heating element to be incorporated in at least one, in particular micro- or nanostructured insert, in order to increase the contour accuracy of the shaping and to obtain a higher so-called aspect ratio, i.e. in order to be able to produce higher and narrower structures.

It is also conceivable to couple the heating element into the surface structuring of the at least one insert, in order to beat the injection moulding compound in a targeted manner and directly in the regions in contact with the injection moulding compound. The aspect ratio of the structured moulding surfaces can thus be further improved.

In particular, an independent invention is seen in the mould of an injection moulding device according to the invention. The parts of the mould not primarily relevant for the function of the injection moulded article can be designed with conventional production methods according to ISO 2768-1 and ISO 2768-2 classified in particular as “fine” or “high”.

The mould contains at least one insert. The at least one insert can be coated by means of an imprint process at least on the surface of the insert to be moulded and can thus be functionalised.

The at least one insert with higher demands on surface quality, functionalisation, such as in particular microstructured periodic surface structures, is preferably produced with so-called micro-replication, in particular micro- or nano-lithographic imprint processes and, in the mould, is integrated as at least one partially elastic insert into the mould. As a result of this surface coating by means of the imprint processes, the at least partially elastic structures on the at least one insert can advantageously be replicated individually and precisely on the injection moulded article.

The surface structures of the at least one insert are produced for example by means of lithographic imprint technology on the given insert, in particular like the technology that is described in detail in the publication EP2870510B 1.

The at least one insert, which can contain for example inorganic carriers, preferably semiconductor materials, and/or particularly preferably SiN and/or SiC and/or diamond and/or technical glass, is fixed in the mould preferably in a manner capable of being aligned. The at least one insert is therefore locally fixed, but can be moved in a targeted manner and can thus be mounted fixed at another position.

It is also conceivable for an in particular elastic structure to be first produced on a carrier with known imprint lithography technology, which is subsequently transferred onto the surface of the at least one insert. For the transfer of the structure, use may be made in particular of plasma activation and/or adhesive. Preferably, however, the elastic structures are produced directly on the surface of the at least one insert. An aligner can be used for the alignment and/or prefixing of the structuring on the surface of the at least one insert. For example, a processing laser can be used for the fixing of the carrier on the at least one insert or can be integrated in the mould.

In a particularly preferred advantageous embodiment of the mould, it is possible to align and fix the at least one insert in the mould with an aligner known from semiconductor technology. The alignment accuracy of the at least one insert in the mould is in this case better than 5 μm, preferably better than 1 μm, particularly preferably better than 500 nm, very particularly preferably better than 250 nm, in particular in the lateral plane of the mould. The same alignment accuracy can be provided by the aligner or other aligners in different movement directions of the mould.

The alignment accuracy of the at least one insert in the mould is preferably measured on the produced injection moulded article. In a series production process, therefore, the first or the first produced injection moulded article can be measured and the alignment accuracy can thus be determined by a comparison of the measured actual values with predefined set values.

An aligner is preferably integrated in the injection moulding device as an alignment module. Accordingly, with a modular design, the devices with modules such as measurement modules for measuring the injection moulded article, a material preparation module, can be added to the injection moulding device in a flexible manner and according to the application requirement.

In particular, it is conceivable to modify a so-called mask aligner from the semiconductor industry, so that existing optical systems, which generate monochromatic UV radiation, can be used. Thus, it is also conceivable for the injection moulding device to contain an aligner and imprinter for producing an, in particular, elastic micro- or nanostructured surface on an insert.

Furthermore, it is preferably conceivable to align the at least one insert in the mould in a combined aligner and to prefix the latter in the mould, in particular using high-energy radiation, in particular with a laser or heating, so that the insert with an elastic surface coating is fixed in the mould in the correct position and the mould can be moved.

The fixing represents a connection of the at least one insert to the mould, which is adapted or designed for operating conditions (excess pressure up to over 2000 bar, preferably over 2400 bar, temperatures of the imprint compound and of the mould up to over 150 degrees Celsius, preferably up to over 200 degrees Celsius). As a result of the fixing, the at least one insert is fixed in the mould in the correct location and position, in particular free from constraint.

The constraint-free fixing of the at least one insert in the mould means that precisely six degrees of freedom of movement are taken from the at least one insert. Deformations on account of parasitic forces on the insert are thus advantageously prevented.

The alignment accuracy of the inserts with one another, again measured on the injection moulded article, is referred to by the person skilled in the art as the resultant alignment error. The alignment error thus exists relatively between the insert and a second component, in particular a further insert.

The alignment error, in particular relatively measured for two inserts facing one another with their respective moulding surfaces, on the injection moulded article is preferably less than 10 μm, preferably less than 5 μm, particularly preferably less than 1 μm, very particularly preferably less than 500 nm, with utmost preference less than 200 nm.

Smaller alignment errors are necessary for special, and in particular optical, applications. The alignment error on the injection moulded article is thus less than 150 nm, preferably less than 100 nm, particularly preferably less than 50 nm.

In cases in which periodic, preferably identical or periodically repeating structures are moulded in the injection moulded article, it is important for the functionality that the periods are aligned with one another.

Whether the periods are aligned to one another as “peak to peak” or “valley to valley” or “valley to peak” is not relevant for the consideration of the periodic error on the injection moulded article. The periodic error is thus to be regarded as a deviation from the ideal, predefined alignment state. Only the deviation counts, i.e. the defect on the injection moulded article. It is thus advantageously possible to indicate the alignment state of the periods with respect to one another as a quality feature. An alignment error, which is precisely one period, only causes an error at the edge of the imprint structures of the injection moulded article, in other words an offset by the length of a period.

The alignment error, in particular periodic error, should amount here to less than 0.25 periods, preferably less than 0.1 periods, particularly preferably less than 0.05 periods, measured on the injection moulded article.

The alignment error must also be minimal in relation to the rotation. Over a distance of 50 mm, the structures should not deviate more than 0.5 μm. That corresponds to a maximum angle of 10⁻⁵°. The alignment error in relation to the angle is therefore less than 10⁻⁵°, preferably less than 10^{-6°}, still more preferably less than 10⁻⁷°, most preferably less than 10^{-8°}, with utmost preference less than 10⁻⁹°.

In other words, a rotation error with a reference length of 50 mm is less than 1 μm, preferably less than 500 nm, particularly preferably less than 250 nm, very particularly preferably less than 100 nm, measured at the periphery and/or edge of the article.

In a preferred embodiment of the injection moulding device, the injection moulding compound can contain a light-sensitive curing, in particular UV-curing component. With the use of such an injection moulding compound, no heat-related curing or phase transition from a liquid into a solid of the injection moulding compound takes place, but rather a phase transition based on UV radiation.

The mould in this embodiment of the injection moulding device contains integrated radiation sources and/or radiation windows which are transparent for the curing radiation and through which the curing radiation irradiates the injection moulding compound in order to initiate curing. The mould is transparent in a preferred embodiment.

Technical polymers and/or so-called commodity plastics, in other words polymers from mass production, can be used as an injection moulding compound. The material selection is guided by the intended use of the injection moulded article.

Polymers and/or their mixtures and/or blends can be used with or without fillers, which contain in particular the following materials:

POSS

polyethylene (LDPE, HDPE) and/or

polypropylene (PP, also chlorinated PVC), and/or

polystyrene, and/or

methacrylate (PMMA), and/or

terephthalate (PET), and/or

fluorinated polymers (PTFE), and/or

TPO, CAB, ABS, PA-66, POM, PC, PPS, PES, LCP, PEEK, PF, UF, UP, EP, PIB and/or PIM.

The shrinkage of the injection moulding compound used preferably amounts to less than 5%, particularly preferably less than 3%, still more preferably less than 1.7%, most preferably less than 0.7%.

A second embodiment of an injection moulding device contains at least one modified mould with two inserts, which are to be aligned with one another and which carry out the functionalisation of the injection moulded article with in particular the elastic, preferably microstructured and/or nanostructured surfaces.

In this embodiment of the injection moulding device, at least two inserts with in particular elastic microstructured and/or nanostructured insert surfaces can be aligned with one another and fixed in the mould.

The alignment accuracy of the inserts with one another in the mould amounts to the same as the alignment accuracy of one insert in the mould.

It is possible to arrange the inserts in the mould in such a way that they fall on different mould halves of the parting plane of the mould. The device and the method for injection moulding can thus be designed particularly flexibly with regard to the position of the inserts in the mould.

In order to carry out the alignment procedure of the inserts with one another with a high level of accuracy, it is possible for the mould to be designed at least partially transparent. In other words, the mould can have removable support parts, which serve for the transfer of force and uniform force distribution of the contact pressure, as well as inspection windows or alignment windows, with the aid of which an alignment of the inserts or the structured surfaces of the inserts can take place in a completely closed state of the mould. In order to be able to absorb the forces and temperature fluctuations of the injection moulding process with the in particular elastic, microstructured inserts and inspection windows and/or alignment windows, the mould can contain corresponding support structures. The inspection windows can in particular also be designed for the curing of the injection moulding compound with UV radiation.

In order to be able to carry out a precise alignment of the insert/the inserts in the at least two mould halves of the mould, it is necessary for the inserts to be aligned with one another in the closed mould. It is thus possible to compensate for or to correct alignment errors of the insert or the inserts with one another, which arise during the closing or in the closed state of the mould or already during the fixing in the mould.

The alignment can take place for example by means of so-called alignment marks or markings. The latter are applied on the insert or on the inserts. There is preferably at least one marking on each insert, which can be aligned in the closed state of the mould.

The alignment preferably takes place by an optical alignment of at least one marking, which is arranged on the rear side of the insert, with an alignment mark which is arranged on the rear side of a further insert. The alignment can thus advantageously take place via the rear sides of the inserts facing away from the respective moulding surfaces.

In the semiconductor industry, the markings or alignment marks can include standard crosses, propeller-like alignment marks, circles, polygonal patterns, linear patterns for optical interference, QR codes.

The alignment marks as preferably arranged in a mark field, wherein the individual alignment marks have an information content, so that the position in the mark field and therefore the position of the corresponding insert relative to an optical alignment means is known. An alignment can then advantageously take place relatively, on the basis of the known position of the individual marks in the mark field.

It is particularly advantageous if an insert contains alignment marks or markings on two surfaces lying opposite one another. The latter are preferably located on the respective rear side of the insert and on the respective side of the moulding surfaces of the insert. Alignment can thus advantageously take place from both sides of the insert.

It is very particularly preferable for the injection moulding device to comprise an aligner and fixing for two inserts, wherein the aligner carries out a correlation of surface structurings, which then function in particular as alignment marks, on the moulding surface, with alignment marks on the rear side of the insert, wherein the correlation is based in particular on image evaluation. By means of the correlated data, a rear-side to rear-side alignment of at least two inserts can be carried out. The optical alignment means for the detection of the respective alignment marks on the rear side can be arranged inside the mould. The alignment of the inserts with one another can thus advantageously take place in the closed state of the mould.

It is also conceivable for the alignment to take place by alignment means arranged outside the mould, which can detect the alignment marks or the markings of the inserts through channels or inspection windows for example.

A surface structuring of the insert can take place, in particular in an aligned manner on the insert surface or the moulding surface, so that the position and location of the in particular soft surface structures can be measured. In this case, the surface structures can advantageously serve as alignment marks or markings. In particular, it is conceivable for the inserts to have further markings or alignment marks on the rear side, which can be measured relative to the surface structures. When the marking is measured, the position of the surface structures lying opposite is thus also known and vice versa.

The insert can comprise different regions or different layers of the surface structures. The latter can contain surface structures to be replicated and/or surface structures not to be replicated, in particular alignment marks. The surface structures can be created in a so-called “first print” or in sequential production.

In an advantageous embodiment of the device, markings, in particular alignment marks, can be provided and/or applied and/or introduced on the surface of the insert provided in particular with soft structures to be replicated and on the surface of the insert opposite the latter. In other words, the insert can contain alignment marks and/or alignment mark fields on both surfaces, which in particular by means of lithography or electron beam qualify the insert for alignment in an aligner.

The alignment marks of the surface structuring are preferably measured in relation to the same surface of the insert, in order to be able to verify the position of surface structures on the insert.

Particularly preferably, the measuring and the referencing of the alignment marks of the surface structuring to the alignment marks of the non-surface structured (imprinted) side of the insert is provided. In other words, a correlation of the surface structuring (in particular its position and/or location) with the rear side of the insert is created. It is thus possible to align the surface structures of the inserts with one another in such a way that they are not directly optically accessible for an aligner. With the correlation of the front side of the insert with the rear side, the inserts can be aligned with one another on the basis of the non-surface structured (imprinted) rear sides, as though the surface structurings were aligned directly with one another.

Very particularly preferably, the alignment of the inserts with one another is carried out in the closed mould.

Since all the surface-structured inserts can be measured and can in themselves be correlated, the measured alignment errors of the injection moulded article can be corrected with the aid of error correction vectors, which are derived from the alignment errors of the injection moulded articles, the inserts being better aligned with one another.

The checking of the alignment success results from the measurement of the produced injection moulded articles or the determination of the alignment error on the basis of a produced injection moulded article.

In particular, provision is made such that the inserts can be positioned or can be aligned in the closed mould by a feed motion of less than 1000 μm, preferably less than 500 μm, particularly preferably less than 250 μm, in particular by means of flexure bearings, in particular play-free.

In a further preferred embodiment, air bearings integrated in the mould can promote the movement of the inserts. An easily and very precise alignment is thus enabled.

In other words, the feed motion means the maximum possible travel of the insert in the mould during the alignment.

It follows from the maximum travel or the maximum possible feed motion that the alignment marks cover at least an area which is larger than the vector sum of the travel vectors of the positioning device or the alignment device. For example, if 1 mm can be travelled in the x-direction and if 1 mm can also be travelled in the y-direction, the alignment marks should be present on an area greater than 1 mm\hat{ }2 in the field of vision of the aligner.

Provision is made such that the inserts can be positioned by means of fine-positioners, in particular with piezo drives and/or differential-screw actuators.

For example, piezo drives, linear piezo drives, screw drives, amongst others, can be used.

Provision is also made such that the inserts, after being aligned with one another in the mould, are fixed in such a way that the production of a series of injection moulded articles or at least the production of an at least statistically relevant sample of injection moulded articles displaces the position and the location of the inserts by less than 1%, preferably by less than 50 ppm, particularly preferably by less than 100 ppb. The displacement relates to the ideal value of the produced articles. In other words, the dispersion of the production errors in respect of the location and/or position of the inserts is kept within a narrow tolerance field below 1%, preferably less than 50 ppm, particularly preferably below 100 ppb.

Once the iterative corrections in the position and location of the inserts in the mould has been completed, which as an effect is accompanied by minimisation of the production error on the injection moulded article, the inserts can be fixed in the mould for an, in particular, serious production.

Fixing in this case is understood to mean that detachment of the insert from the mould cannot take place without damage to the insert (in particular due to a high degree of adhesion to the mould).

It is conceivable for a replacement of a fixed insert to be required. In this case, the insert may be destroyed, but the functionality of the mould should remain apart from necessary cleaning and can accommodate a further insert without reworking of the mould.

In a preferred embodiment of the mould in the injection moulding device, provision is advantageously made such that in particular the shape and location tolerances of the injection moulded article are increased with the disclosed method, in particular by means of reworking of the elastic surface structures of at least one of the inserts and/or by means of reworking of at least one of the inserts. In particular, the plane-parallelism of the injection moulded article can be improved.

Furthermore, provision is made such that the mould or the arrangement of the insert or the inserts are adjusted in an iterative, in particular approximating validation process.

A mould is created with which an, in particular, statistically relevant quantity of injection moulded articles, in particular series, is produced.

The injection moulded articles are measured and in particular statistically evaluated. An average alignment error can thus advantageously be ascertained.

A correction of the mould, in particular an adjustment of the insert, can then be carried out on this basis. This correction can consist for example in the fact that material is removed or added and/or the orientation is changed and/or the location of the insert is adapted.

Corrected injection moulded articles are produced and evaluated in a, in particular, statistically relevant quantity. A further approximation of the ideal injection moulded article is either carried out iteratively or the production of the injection moulded article is started.

A statistical evaluation of random samples of the injection moulded article can be carried out for the further error correction, in order to be able to carry out further necessary adaptations. In particular, provision is made such that the ageing influences and wear on the mould can be detected early.

In other words, individual adaptation and adjustment for each mould of the injection moulding device takes place before series production of the injection moulded article, which improves the quality of the injection moulded article and enables narrower tolerances of the injection moulded article, in particular in the regions produced by micro-technology.

A first preferred illustrative method for injection moulding is carried out in particular with the following steps, preferably with the following sequence.
The mould is provided with at least one elastic microstructured or nanostructured insert.
The mould is closed.
In particular in the integrated aligner (alignment module), the insert is aligned with the mould and/or the inserts are aligned with one another, in particular rear side to rear side, and fixed in the mould.
The mould is installed in the injection moulding device.
At least one injection moulded article is produced in particular by means of the injection moulding process.
The injection moulded article is removed from the mould and measured in particular in a 3-D coordinate measuring machine. The data are relayed to the data memory and data analysis device.
The injection moulded article is examined and/or tested for function in an optional process step.
An error-vector field is created by the computer, which is derived from the measured values and from the set values. The correction factors and correction measures are determined.
The targeted corrections are applied.
The targeted corrections include the change in the position and location of the at least one insert in the mould.
A further iteration of the adjustment of the mould and of the insert is optionally carried out.

A further preferred illustrative method for injection moulding comprises in particular the following process steps, in particular with the following sequence.

The mould is prepared in preparatory process steps. For this purpose, it is necessary to functionalise the inserts with the surface structures. The correlation of each insert is measured from the surface structures to the rear side of the insert and processed in particular in a computer as a data memory and data analysis device.
The mould is provided with, in particular, elastic microstructured or nanostructured inserts.
The mould is closed.
In particular in the aligner integrated into the injection moulding device (alignment module), the inserts are aligned with one another, in particular rear side to rear side, and fixed in the mould.
The mould is installed in the injection moulding device.
At least one injection moulded article is produced in particular by means of the injection moulding process.
The injection moulded article is removed from the mould and measured in particular in a 3-D coordinate measuring machine. The data are relayed to the data memory and data analysis device.
The injection moulded article is examined and/or tested for function in an optional process step.
An error-vector field is created by the computer, which is derived from the measured values and from the set values. The correction factors and correction measures are determined.
The targeted corrections are applied.

The corrections can include at least local material build-up or at least local material removal or a modification of the surface structuring. In particular, the thickness variations of the injection moulded article or waviness can be changed with a targeted material removal or material build-up of the rear side of the insert.

Press-in pressure present in injection moulding can be used, in order to utilise the occurring deformation of the insert in a targeted manner and to influence the shape of the injection moulded article at least locally.

If material is removed at least locally from the rear side of the insert, the volume of the injection moulded article is increased. Local depressions in the injection moulded article can thus be corrected.

If material is built up at least locally at the rear side of the insert, the volume of the injection moulded article is reduced.

The person skilled in the art can use the targeted processing methods to build up the layers such as vapour deposition or PVD or CVD or molecular beam epitaxy or use discrete underlay films. Electron beam ablation or laser ablation or singeing or lapping or grinding or sand grinding or plasma treatment or treatment with an ion cannon are conceivable for the layer removal. In the sense of the alignment, the person skilled in the art can use all known processing methods.
The modified insert is installed in the mould and a further iteration of the production of the injection moulded article begins, until a termination criterion is reached.

A possible termination criterion is the reaching of the qualitative, functional criteria of the injection moulded article. A further termination criterion can be an irreparable deterioration in the injection moulded article, so that the mould and/or the insert are examined and replaced.

Further advantages, features and details of the invention emerge from the following description of preferred examples of embodiment and with the aid of the drawing.

### BRIEF DESCRIPTION OF DRAWINGS

FIG. 1 shows a mould for a device according to the invention for injection moulding.

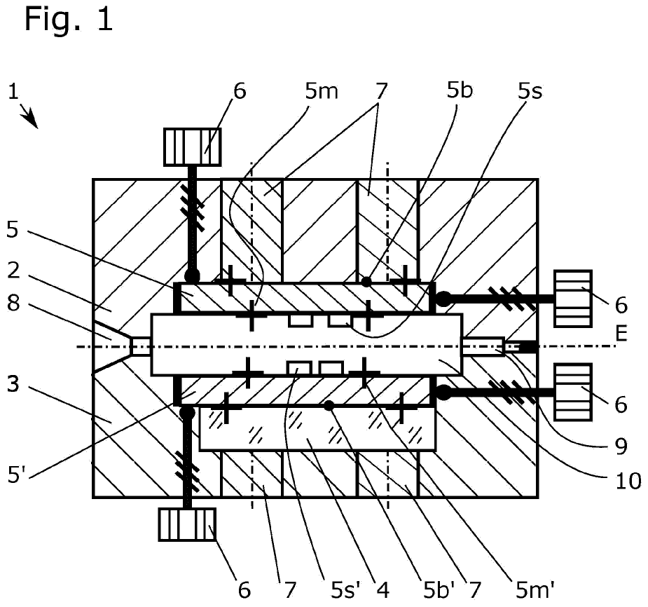

Identical components or components with the same function are denoted with the same reference numbers in the FIGURE.

### DETAILED DESCRIPTION OF INVENTION

Mould 1 comprises first mould half 2 and a second mould half 3, which can be separated from one another through mould parting plane E.

The technological design of mould 1 determines the number of required mould parts and the number of mould parting planes. The necessary guides, pass-cones, as well as ejector bolts, media supply for cooling and/or heating, electronic assemblies for a heating element, deburrers, cutting tool for truncating the filling channel, which are known to the person skilled in the art, are not represented pictorially.

The device also comprises first insert 5 and a second insert 5′. According to the invention, inserts 5, 5′ comprise a polymer.

Represented in second mould half 3 is an inspection window 4, which separates second mould half 3 from an injection moulding space 10 and from insert 5′, in particular in a pressure-tight manner. Alignment marks 5m′ of insert 5′ in particular with an aligner not represented can be observed through inspection window 4 and adjusted by means of positioning mechanism 6.

Pressure distributors 7 enable inspection window 4 and/or the rear side of insert 5b′ to be covered with alignment marks 5m′ during injection moulding, in order to keep the operating pressure during injection moulding up to for example 2500 bar, without the injection moulding compound (not represented) being able to escape from mould 1, in particular in an uncontrolled manner.

Inserts 5, 5′ are positioned, in an alignable and adjustable manner, with structured moulding surface 5s, 5s′ in the direction of injection moulding space 10 in mould 1, in particular in mould halves 2, 3.

Inserts 5, 5′ can comprise alignment marks 5m, 5m′ both on structured moulding surface 5s, 5s′ and also on the rear side of insert 5b, 5b′, constituted in particular as mark clusters, in order in particular to be able to carry out referencing or correlation of moulding surface 5s, 5s′ of inserts 5, 5′ with rear side 5b, 5b′ of inserts 5, 5′. The measurement does not necessarily take place in mould 1.

In a particularly preferred embodiment not represented, processing of rear side 5b, 5b′ of insert 5, 5′ can take place to achieve flatness requirements, wherein moulding surface 5s, 5s′ of insert 5, 5′ can be used without structuring. In particular cases, moulding surface 5s, 5s′ of insert 5, 5′ can be present without structuring irrespective of the processing or processability of rear side 5b, 5b′ of insert 5, 5′.

Mould 1 is filled in filling opening 8 with the injection moulding compound (not represented), so that it passes into injection moulding space 10 and in particular completely fills the cavities of injection moulding space 10. In order to be able to fill injection moulding space 10 of mould 1 completely without air bubbles or voids or inclusions, venting ducts 9 in particular are formed in mould 1.

Insert 5 without an inspection window is depicted symbolically in first mould half 2. Channels are correspondingly formed in mould 1, in order to be able to observe in particular rear side 5b of insert 5 with optical means and to align inserts 5, 5′ with one another. In this embodiment, pressure distributors 7 support insert 5, 5′, in order to protect it against breakage due to overloading with the injection moulding compound.

Overloads of insert 5, 5′ can include a thermal overload and a mechanical overload, which can be prevented by constraint-free clamping and an in particular full-area support of insert 5, 5′ in mould 1.

### LIST OF REFERENCE NUMBERS

1 mould for injection moulding
2 first mould half
3 second mould half
4 inspection window
5, 5′ insert
5s, 5s′ structured moulding surface of the insert
5b, 5b′ rear side of the insert
5m, 5m′ alignment marks of the insert
6 positioning mechanism
7 pressure distributor
8 filling opening
9 venting duct
10 injection moulding space
E mould parting plane

1-15. (canceled)

16. A device for injection moulding to produce an injection moulded article, said device comprising:
a mould with a first mould half and a second mould half, wherein the first mould half and the second mould half define an injection moulding space in a closed state of the mould;
at least one insert arranged in the injection moulding space; and
at least one further insert arranged in the injection moulding space,
wherein the at least one insert at least partially comprises a polymer,
wherein the injection moulded article can be removed from the at least one insert and measured;
wherein an alignment error can be determined by comparison with set values,
wherein the at least one insert can be aligned,
wherein the at least one insert and/or the at least one further insert can be aligned in the closed state of the mould, and
wherein the alignment error can be iteratively improved by repeatedly carrying out the alignment.

17. The device according to claim 16, wherein the at least one insert and/or the at least one further insert respectively comprises/comprise a moulding surface with elastic structures.

18. The device according to claim 17, wherein the moulding surface of the at least one insert and the moulding surface of the at least one further insert can be aligned with one another in the closed state of the mould.

19. The device according to claim 17, wherein the elastic structures of the moulding surface of the at least one insert and the structures of the moulding surface of the at least one further insert can be aligned with one another in the closed state of the mould.

20. The device according to claim 16, wherein at least one heating element is/are integrated into the at least one insert, into the at least one further insert and/or into the respective elastic structures, so that an injection moulding compound which can be conveyed through a filling opening into the injection moulding space, can be heated in a targeted manner by means of the at least one heating element.

21. The device according to claim 16, wherein the at least one insert and/or the at least one further insert comprises/comprise a plurality of alignment marks.

22. The device according to claim 21, wherein the plurality of alignment marks are located on the respective moulding surface and/or on a respective rear side of the at least one insert and/or the at least one further insert,

23. The device according to claim 16, wherein the first mould half and/or the second mould half comprises/comprise an inspection window, so that the at least one insert and/or the at least one further insert can be aligned and/or can be aligned with one another by means of a plurality of alignment marks in the closed state of the mould.

24. The device according to claim 16, wherein the first mould half and/or the second mould half in each case comprises/comprise at least one positioning mechanism, so that the at least one insert and/or the at least one further insert can be aligned with the aid of a plurality of alignment marks in the closed state in the mould.

25. The device according to claim 16, wherein, with aid of a plurality of alignment marks on a rear side of the at least one insert (5) and/or on a rear side of the at least one further insert, elastic structures of the moulding surface of the at least one insert and elastic structures of the moulding surface of the at least one further insert can be aligned with one another in the closed state of the mould.

26. A method for injection moulding, wherein an injection moulding space is defined by a mould with a first mould half and a second mould half in a closed state of the mould, and wherein at least one insert arranged in the injection moulding space (10) is at least partially comprised of a polymer, said method comprising:
producing an injection moulded article;
removing the injection moulded article from the at least one insert;
measuring the injection moulded article;
determining an alignment error by comparison with set values, wherein the at least one insert is aligned;
aligning the at least one insert and at least one further insert arranged in the injection moulding space, wherein the at least one insert and the at least one further insert are aligned with one another in the closed state of the mould in the injection moulding space; and
repeatedly carrying out the aligning to iteratively improve the alignment error.

27. The method according to claim 26, wherein the aligning of the at least one insert and the at least one further insert includes aligning a moulding surface of the at least one insert and/or a moulding surface of the at least one further insert.

28. The method according to claim 26, wherein the at least one insert and/or at least one further insert is/are aligned with the aid of a plurality of alignment marks provided on the at least one insert and/or the at least one further insert.

29. The method according to claim 26, wherein an alignment of the at least one insert and/or of the at least one further insert is carried out on the basis of a measurement of an injection moulded article.

30. The method according to claim 26, wherein an alignment is carried out by a reworking of the at least one insert and/or of the at least one further insert.
